(19) United States
(12) Patent Application Publication
(10) Pub. No.: US 2025/0154435 A1
(43) Pub. Date: May 15, 2025

(54) METHOD OF CLEANING

(71) Applicant: Bachman Services LLC, Oklahoma City, OK (US)

(72) Inventors: Gregg Compton HAIGHT, Edmond, OK (US); Les V. Robertson, Purcell, OK (US)

(21) Appl. No.: 18/947,608

(22) Filed: Nov. 14, 2024

Related U.S. Application Data
(60) Provisional application No. 63/599,339, filed on Nov. 15, 2023.

(51) Int. Cl. C11D 1/83; C11D 1/00; C11D 1/22; C11D 1/66; C11D 3/37; C11D 3/43

(52) U.S. Cl. CPC C11D 1/83; C11D 3/3776; C11D 3/43; C11D 1/008; C11D 1/22; C11D 1/662

(57) ABSTRACT

Novel cleaning compositions and methods for providing cleaning to industrial equipment.

### FIELD

The invention relates to the use of one or more biosurfactants to provide cleaning to an item of industrial equipment and to a method of cleaning an item of industrial equipment using one or more biosurfactants. The invention also relates to a cleaning composition comprising one or more biosurfactants.

### BACKGROUND

It is well known that equipment used in industrial processes and storage often becomes fouled with undesirable substances that soil the equipment. This may be due to the equipment contacting substances such as reagents, products and/or contaminants, which can adhere to a surface of the equipment. It is necessary to remove these undesirable substances, for example in a cleaning process, in an effective and efficient manner so that the equipment can be re-used. It is also desirable for methods of cleaning to be environmentally acceptable, for example by using components that are considered not to provide an undesirable impact to the environment.

For example, substances such as polymers may adhere to surfaces of polymerisation reactors, storage vessels, transfer equipment and tanks, tank trailers and dosing equipment. Current methods to remove the polymers include high pressure jet washing with large amounts of water, and the use of sulfate salts in aqueous compositions.

Adhesives and tar are examples of other substances that need removing from equipment. For example, tar may need removing from equipment such as storage vessels, transfer equipment and tanks, tank trailers and equipment used for laying tar or asphalt. Current methods to remove tar or asphalt include using commercially available products that comprise butyl glycol, isopropyl alcohol, methylene chlorides and optionally synthetic surfactants. Adhesives may need removing from storage vessels (including portable storage vessels) and following removal of adhesive labels. Current methods to remove adhesives include using commercially available products that comprise D-limonene, aliphatic alkanes and/or acetone.

There is a need for alternative and/or improved methods for cleaning industrial equipment, which methods should work with a wide range of substances and clean effectively and efficiently and reduce the amount of water required in cleaning methods. Such methods should also use components that are considered not to undesirably impact the environment.

It is thus an object of the present invention to provide methods of cleaning industrial equipment, which methods may be more effective than, or which may provide an alternative to, existing methods of cleaning.

### SUMMARY

According to a first aspect of the invention, there is provided the use of one or more biosurfactants to provide cleaning to at least a portion of an item of industrial equipment.

According to a second aspect of the invention, there is provided a method of cleaning at least a portion of an item of industrial equipment, the method comprising contacting the portion of the item of industrial equipment with one or more biosurfactants.

According to a third aspect of the invention, there is provided a cleaning composition comprising one or more biosurfactants and one or more additive compounds independently selected from a non-biological anionic surfactant, a succinic acid derived dispersant and a terpene.

### DETAILED DESCRIPTION

Unless otherwise stated, the following terms used in the specification and claims have the meanings set out below.

The terms “alkyl” and “alkylene” include both straight and branched chain alkyl and alkylene groups respectively unless otherwise stated.

The term “hydrocarbyl” is used in its ordinary sense, which is well-known to those skilled in the art. Specifically, it refers to a group having a carbon atom directly attached to the remainder of the molecule and having predominantly hydrocarbon character.

As used in the specification and the appended claims, the singular forms “a”, “an,” and “the” include both singular and plural referents unless the context clearly dictates otherwise.

Throughout this specification, the term “comprising” or “comprises” means including the component(s) specified but not to the exclusion of the presence of other components. The term “consisting essentially of” or “consists essentially of” means including the components specified but excluding other components except for components added for a purpose other than achieving the technical effect of the invention. The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

As used herein, unless otherwise expressly specified, all numbers such as those expressing values, ranges, amounts of percentages may be read as if prefaced by the word “about”, even if the term does not expressly appear.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.70 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

The optional features set out herein may be used either individually or in combination with each other where appropriate and particularly in the combinations as set out in the accompanying claims. The optional features for each exemplary aspect of the invention, as set out herein are also applicable to any other aspects or exemplary aspects of the invention, where appropriate. In other words, the skilled person reading this specification should consider the optional features for each aspect or embodiment of the invention as interchangeable and combinable between different aspects of the invention.

As used herein, the term “and/or,” when used in a list of two or more items, means that any one of the listed items can be employed by itself or any combination of two or more of the listed items can be employed. For example, if a list is described as comprising group A, B, and/or C, the list can comprise A alone; B alone; C alone; A and B in combination; A and C in combination, B and C in combination; or A, B, and C in combination.

According to a first aspect of the invention there is provided the use of one or more biosurfactants to provide cleaning to at least a portion of an item of industrial equipment.

According to a second aspect of the invention there is provided a method of cleaning at least a portion of an item of industrial equipment, the method comprising contacting the portion of the item of industrial equipment with one or more biosurfactants.

By “industrial equipment” we mean equipment that is used in an industrial setting and scale, for example that is used in large scale manufacturing, storage, extraction, processing, treatment and/or transportation. Examples of industrial equipment will be well known to persons skilled in the art and include marine and oilfield equipment, such as machinery and engines (including components thereof) that may be used in a marine or oilfield environment. Examples of industrial equipment, including marine and oilfield equipment, as provided herein are non-limiting.

References to cleaning industrial equipment are intended to refer to at least partially removing undesirable substances (such as oil, tar, asphalt, polymer, adhesive, grease, paint and sludge) from the industrial equipment, for example to the partial or complete removal of undesirable substances (such as oil, tar, asphalt, polymer, adhesive, grease, paint and sludge) from at least a portion of an item of industrial equipment. Typically, the cleaning is from a surface of the industrial equipment. The industrial equipment typically comprises a solid surface to be cleaned. For example, the cleaning may comprise the cleaning of a portion of a surface of the industrial equipment, or may comprise cleaning an entire such surface. References to cleaning at least a portion of an item of industrial equipment include cleaning one or more components or constituent parts of the item of industrial equipment, for example wherein the component or constituent part may have been in contact with an undesirable substance to be removed. For example, the cleaning may comprise the cleaning of one or more components or constituent parts of the industrial equipment, such as a surface thereof, or may comprise cleaning an entire such component or constituent part.

Suitably, the cleaning comprises at least the partial removal of a substance from the portion of the item of industrial equipment, wherein the substance is selected from one or more of oil, tar, asphalt, polymer, adhesive, grease, paint and sludge. The substance may comprise a silicone component, for example the substance may comprise an adhesive or grease that comprises a silicone component.

References to sludge are intended to refer to all types of sludge, including hydrocarbon and bacterial sludge.

Examples of cleaning herein may include cleaning and/or removing paint from industrial equipment, cleaning and/or removing grease (such as silicone-based grease) from industrial equipment such as machinery, and cleaning and/or removing adhesive (such as silicone-based adhesive) from industrial equipment.

The industrial equipment may be oilfield equipment. By “oilfield equipment” we mean equipment that is used in oil and gas fields, for example equipment that is used in the drilling, completion, fracturing, transportation and refining of oil, gas and water by-products. Examples of oilfield equipment will be well known to persons skilled in the art, and include any equipment in the oil and gas industry that needs cleaning. Typical oilfield equipment includes well casings, drilling equipment, mud handling equipment, pipelines and storage vessels and tanks. The oil and gas fields may be on-shore or off-shore.

The industrial equipment may be marine equipment. By “marine equipment” we mean equipment that is used in a marine environment. Examples of marine equipment will be well known to persons skilled in the art, and include any equipment used in a marine environment that needs cleaning. Typical marine equipment includes machinery and engines that are a component of a marine vessel.

Examples of cleaning herein may include cleaning and/or removing oil from an engine and cleaning oil spillages.

The industrial equipment may be selected from manufacturing, storage, processing, extraction, treatment and transportation equipment. For example, the industrial equipment may be selected from storage containers, polymerisation reactors, dosing equipment, transfer equipment and tanks, tank trailers and manufacturing equipment.

The industrial equipment (such as the oilfield equipment) may be metallic equipment, by which we mean that it comprises a metal. Suitable metals include iron, zinc, aluminium, copper and/or steel. The metallic equipment may comprise a metal alloy. The industrial equipment may be metallic oilfield equipment.

The industrial equipment may be selected from oil manufacturing, storage, processing, extraction, treatment and transportation equipment.

The industrial equipment may be selected from tar manufacturing, storage, processing, extraction, treatment and transportation equipment. For example, the industrial equipment may be selected from tar manufacturing, storage and treatment equipment.

The industrial equipment may be selected from asphalt manufacturing, storage, processing, extraction, treatment and transportation equipment. For example, the industrial equipment may be selected from asphalt manufacturing, storage and treatment equipment.

The industrial equipment may be selected from polymer manufacturing, storage, processing, extraction, treatment and transportation equipment. For example, the industrial equipment may be selected from polymer manufacturing and transportation equipment.

The industrial equipment may be selected from paint manufacturing, storage, processing, extraction, treatment and transportation equipment. For example, the industrial equipment may be selected from paint manufacturing, storage and processing equipment. The industrial equipment may also comprise any industrial equipment having undesirable residual paint thereon.

The industrial equipment may be selected from grease manufacturing, storage, processing, extraction, treatment and transportation equipment. For example, the industrial equipment may be selected from grease manufacturing, storage and processing equipment. The industrial equipment may also comprise any industrial equipment having undesirable residual grease thereon. The grease may, for example, comprise a silicone-based grease.

The industrial equipment may be selected from adhesive manufacturing, storage, processing, extraction, treatment and transportation equipment. For example, the industrial equipment may be selected from adhesive manufacturing, storage and treatment equipment. The industrial equipment may also comprise any industrial equipment having undesirable residual adhesive thereon, for example following removal of an adhesive backed sticker from a surface of the equipment. The adhesive may, for example, comprise a silicone-based adhesive.

The industrial equipment may be selected from manufacturing, storage, processing, extraction, treatment and transportation equipment that contacts sludge (such as hydrocarbon sludge).

The use of the first aspect of the invention refers to the use of one or more biosurfactants to provide cleaning to industrial equipment. The method of the second aspect of the invention comprises cleaning industrial equipment using one or more biosurfactants. Thus, the use and method of the invention make use of one or more biosurfactants.

References herein to one or more biosurfactants includes mixtures of different biosurfactants when more than one biosurfactant is used.

By the term biosurfactant we mean a surfactant that is produced by microorganisms, for example which may be a product of a fermentation process. Typically, a biosurfactant is generated as a metabolic product during bacterial, fungal or algal fermentation, and the metabolic product may be further derivatised. Thus, references herein to a biosurfactant refer to biosurfactants that are direct metabolic products of bacterial, fungal or algal fermentation, as well as derivatives of the direct metabolic products. Similarly, references herein to a specific biosurfactant also refer to derivatives of that biosurfactant unless otherwise stated.

The use of biosurfactants in the method and use of the invention is advantageous, because biosurfactants are natural products, are generated in a sustainable way, are environmentally benign and typically have low toxicity.

Biosurfactants are typically classified in four categories as polymeric biosurfactants, lipopeptides (or also called proteo-lipids), phospholipids and glycolipids. The one or more biosurfactants may be a complex mixture of biosurfactants.

Biosurfactants may comprise one or more fatty acid and/or fatty alcohol residues. Suitably biosurfactants useful in the invention comprise one or more fatty acid residues.

The one or more fatty acid and/or fatty alcohol residues that may be present in the biosurfactants may be the same or different and may be derived from any suitable fatty acid and/or fatty alcohol, preferably from a naturally occurring fatty acid and/or fatty alcohol. Fatty acid residues are mostly derived from natural plant oils in the form of triglycerides. For example, biocatalysts may hydrolyse lipid esters in natural plant oils forming fatty acids and glycerol. Suitably, the fatty acid and/or fatty alcohol residues may comprise a branched or unbranched, saturated or unsaturated, hydrocarbyl group.

The fatty acid and/or fatty alcohol residues that may be present in the biosurfactants may comprise from 4 to 50 carbon atoms, for example from 6 to 30 carbon atoms, preferably from 8 to 24 carbon atoms, more preferably from 12 to 22, or from 14 to 20 or from 16 to 18 carbon atoms. Preferred biosurfactants may therefore comprise residues of fatty acids derived from oleic acid, hydroxy substituted oleic acid (such as ricinoleic acid), palmitic acid and vegetable oils (such as sunflower, corn, soya, safflower oil and rapeseed oil).

Any suitable biosurfactant(s) may be used. For example, the one or more biosurfactants may be independently selected from a glycolipid, a lipopeptide, a phospholipid and a polymeric biosurfactant (and mixtures thereof).

The one or more biosurfactants may each have any suitable molecular weight, such as a molecular weight of from 200 to 3000 g mol⁻¹, for example from 250 to 2000 g mol⁻¹, such as from 500 to 1500 g mol⁻¹.

The one or more biosurfactants may be glycolipids. Glycolipids comprise one or more carbohydrate residues in addition to the one or more fatty acid and/or fatty alcohol residues. The carbohydrate and fatty acid/fatty alcohol residues are joined either by means of a linker group or a direct bond, for example via an ester, amide or glycosidic bond.

Suitable glycolipids may comprise one or more carbohydrate residues selected from rhamnose, trehalose, sophorose, mannose, galactose, glucose, cellobiose, glucosamine, sulfoquinovose, fructose, xylose, sucrose, lactose, maltose, sorbitol, erythritol and/or mannitol residues. For example, the one or more carbohydrate residues may be selected from rhamnose, trehalose, sophorose, mannose, erythritol, galactose, cellobiose and/or glucose residues. Preferably, the one or more carbohydrate residues may be selected from rhamnose, trehalose, sophorose, mannose and/or erythritol residues. More preferably, the one or more carbohydrate residues may be selected from sophorose and/or rhamnose residues. Most preferably, the one or more carbohydrate residues may be sophorose residues.

Suitable glycolipids may be selected from one or more of a rhamnolipid, a trehalolipid, a sophorolipid, a mannosylerythritol lipid, a glycolipid produced by Meyerozama guilliermondii, Saccharomyces cerevisiae, Candida utilis, Candida bombicola and/or Marinobacter hydrocarbonoclasticus.

For example, suitable glycolipids may be selected from one or more of a rhamnolipid, a trehalolipid, a sophorolipid and/or a mannosylerythritol lipid. Suitably, the one or more biosurfactants are sophorolipids.

For example, the one or more biosurfactants may be independently selected from a rhamnolipid, a trehalolipid, a sophorolipid and a mannosylerythritol lipid. The one or more biosurfactants may be selected from one or more rhamnolipids and/or one or more sophorolipids. Suitably, the one or more biosurfactants are sophorolipids.

Rhamnolipids comprise a rhamnose residue. Examples of suitable rhamnolipids may include those produced by species of Pseudomonas, Lysinibacillus and/or Serratia, for example those produced by Pseudomonas aeruginosa, Pseudomonas cepacia, Lysinibacillus sphaericus and/or Serratia rubidaea.

Trehalolipids comprise a trehalose residue. Examples of suitable trehalolipids may include those produced by species of Nocardia, Rhodococcus, Starmerella, Arthrobacter, Corynebacterium and/or Candida, for example those produced by Rhodococcus erythropolis, Nocardia farcinica and/or Candida bombicola (also known as Starmerella bombicola).

Sophorolipids comprise a sophorose residue. Examples of suitable sophorolipids may include those produced by species of Candida, Starmerella and/or Cutaneotrichosporon, for example those produced by Candida sphaerica, Starmerella bombicola and/or Cutaneotrichosporon mucoides. Suitable sophorolipids may exist in the “lactonic” form wherein a fatty acid residue is bonded separately to each ring of the sophorose residue to form a lactonic macrocycle. When the fatty acid residue is not bonded to a sophorose residue this may be known as the “acidic” form. Suitable sophorolipids may have a molar ratio of acidic to lactonic form in the range 99:1 to 1:99, for example in the range 50:50 to 60:40. Suitable sophorolipids may have a molar ratio of acidic to lactonic form of 70:30. Suitably, greater than 60%, for example greater than 70%, preferably greater than 80%, more preferably greater than 90%, of the sophorolipids may comprise an unsaturated fatty acid and/or fatty alcohol residue.

Mannosylerythritol lipids comprise a mannose residue and an erythritol residue, preferably joined by an ether bond. Examples of suitable mannosylerythritol lipids may include those produced by species of Pseudozyma and/or Ustilago, for example Pseudozyma aphidis or Pseudozyma antarctica.

The one or more biosurfactants may be lipopeptides. Lipopeptides comprise one or more peptide residues in addition to the one or more fatty acid and/or fatty alcohol residues. The one or more peptide residues may be cyclic peptide residues. Suitable lipopeptides may include surfactins, lichenysins, and/or those produced by Pseudomonas azotoformans, Bacillus velezensis, Bacillus pseudomycoides, Virgibacillus salaries, Bacillus cereus, Bacillus pumilius or Halomonas species.

Surfactins may be produced by Bacillus species, such as B. subtillis or B. nealsonii.

Lichenysins may be produced by Bacillus species, such as B. licheniformis.

For example, the one or more biosurfactants may be independently selected from surfactin and lichenysin.

The one or more biosurfactants may be phospholipids. Phospholipids comprise one or more phosphate groups in addition to the one or more fatty acid and/or fatty alcohol residues.

Phospholipids may further comprise a linker group joining the one or more phosphate groups and the one or more fatty acid and/or fatty alcohol residues. Suitable linker groups may for example comprises an alcohol residue such as glycerol or sphingosine. Suitable phospholipids include those produced by species of Acinetobacter and/or Acidithiobacillus, for example Acidithiobacillus thiooxidans.

The one or more biosurfactants may be polymeric biosurfactants. Polymeric biosurfactants are biopolymers (e.g. polysaccharides, polypeptides) comprising fatty acid and/or fatty alcohol residues.

Suitable polymeric biosurfactants include cellulose, guar, diutan, starch, chitin, chitosan, glycogen, xanthan, dextran, dextrin, welan, gellan, pullulan, pectin, scleroglucan, schizophyllan, levan, locust bean gum, peptidoglycan, tara, konjak, tamarind, starch, karaya, tragacanth, carrageenan, glycan, succinoglycan, glucan, scleroglucan, maltodextrin, cyclodextrin, inulin, alginates, amylose, amylopectin, liposan, rufisan, emulsan, lipomanan and/or alasan. Polymeric biosurfactants may include those produced by species of Candida and/or Acinetobacter, for example Candida lipolytica, Acinetobacter lwoffi and/or Acinetobacter radioresistens.

For example, the one or more biosurfactants may be independently selected from liposan, rufisan, emulsan and alasan.

For example, the one or more biosurfactants may be independently selected from a rhamnolipid, a trehalolipid, a sophorolipid, a mannosylerythritol lipid, surfactin, lichenysin, liposan, rufisan, emulsan and alasan.

Biosurfactants useful in the invention may be those produced by species of Pseudomonas, Lysinibacillus, Serratia, Nocardia, Rhodococcus, Candida, Starmerella, Cutaneotrichosporon, Pseudozyma, Meyerozyma, Saccharomyces, Marinobacter, Bacillus, Lactobacillus Virgibacillus, Halomonas, Thiobacillus, Acidithiobacillus, Klebsiella, Alcanivorax, Arthrobacter, Rhodotorula, Tsukamurella, Ustilago, Sphingomonas, Mycobacterium, Streptomyces, Gluconobacter, Aspergillus and/or Acinetobacter.

The biosurfactants that are produced by a specific micro-organism may vary depending on the feedstock used and other variables in the growth conditions (e.g. temperature, pH, agitation and dissolved oxygen). Preferably, feedstocks comprise carbohydrates and/or lipids. Preferred lipid feedstocks are in the form of triglycerides. The feedstocks may comprise agricultural and/or industrial waste, for example vegetable oils, animal or vegetable fats, cooking oil waste, whey, glycerol, and/or combinations thereof. Biosurfactants suitable for the invention are preferably produced by micro-organisms from feedstock comprising carbohydrate and one or more lipids. More preferably, they are produced from feedstock comprising carbohydrate and one or more of vegetable oils (for example rapeseed, palm, sunflower, corn, soya and/or safflower oils), animal fats and vegetable fats.

Biosurfactants useful in the invention may be recovered from the fermentation broth before use by known recovery methods. For example, the biosurfactants may be recovered by precipitation, filtration (including ultrafiltration), adsorption to solid supports, centrifugation, chromatography (e.g. ion-exchange chromatography), foam fractionation, liquid-liquid extraction, and/or gravity separation (decanting).

Biosurfactants useful in the invention may be used as crude extracts, or they may undergo further purification and/or derivatisation before use.

Where biosurfactants are further purified, this may involve one or more purification techniques available to the skilled person, for example chromatographic techniques, ultrafiltration or washing with a suitable solvent (which solvent may be polar or non-polar).

Where biosurfactants are further derivatised, this may comprise derivatisation of the fatty acid and/or fatty alcohol residues. Where the fatty acid or fatty alcohol residue has an unsaturated alkyl group, suitable methods for derivatisation of the fatty acid or fatty alcohol residue include mild reductive, strong reductive or oxidative ozonolysis with sodium periodate (resulting in a dialdehyde, diol or diacid respectively); dihydroxylation, for example with OsO₄; epoxidation, for example with m-chloroperoxybenzoic acid; reduction, for example with H₂ on a Pd/C catalyst; ring opening metathesis; treatment with HBr; or mono-hydroxylation, for example by hydroboration with an oxidative work-up.

Where the biosurfactant is a glycolipid, the carbohydrate may be derivatised at the alcohol groups by esterification (e.g. with an anhydride), carboxymethylation (e.g. with an α-chloro acid), oxidation (to e.g. aldehyde or carboxylic acid), reaction with a non-ionic epoxide (e.g. ethylene oxide, propylene oxide), reaction with a cationic epoxide (e.g. glycidyltrimethyl ammonium chloride). The carbohydrate may be further derivatised by oxidative ring opening (e.g. with a periodate) resulting in a dialdehyde.

Derivatives of biosurfactants comprising aldehyde groups may be further derivatised, for example to alcohols, carboxylic acids, esters, amides, imines and/or amines. Derivatives of biosurfactants comprising carboxylic acid groups may be further derivatised, for example to esters and/or amides. Derivatives of biosurfactants comprising 1,2-diol groups may be further derivatised, for example by C—C bond cleavage with periodate or peroxide, or reaction with an aldehyde.

The use of the first aspect and the method of the second aspect of the invention may provide cleaning using one or more additive compounds in addition to the one or more biosurfactants.

Thus, the first aspect of the invention may provide the use of one or more biosurfactants and one or more additive compounds to provide cleaning to at least a portion of an item of industrial equipment.

Thus, the second aspect of the invention may provide a method of cleaning at least a portion of an item of industrial equipment, the method comprising contacting the portion of the item of industrial equipment with one or more biosurfactants and one or more additive compounds.

Thus, for example, the use and method of the invention may make use of one or more biosurfactants and one or more additive compounds. In this case, the one or more biosurfactants and the one or more additive compounds may be used or contacted with the portion of the item of industrial equipment together, for example as components of a cleaning composition (such as a cleaning composition as disclosed herein), and/or separately. When the one or more biosurfactants and the one or more additive compounds are used or contacted with the portion of the item of industrial equipment separately, the one or more biosurfactants and the one or more additive compounds may be used or contacted concurrently or sequentially in any suitable order.

The one or more additive compounds discussed in relation to the use and method of the first and second aspects of the invention may comprise any suitable additive compounds. For example, the one or more additive compounds may comprise one or more additive compounds independently selected from a non-biological anionic surfactant, a succinic acid derived dispersant and a terpene, as discussed herein in relation to the cleaning composition. For example, the one or more additive compounds may additionally or alternatively comprise an additional additive selected from one or more of a solvent, a pH adjusting agent, a preservative and a stabiliser as discussed herein in relation to the cleaning composition.

The one or more biosurfactants may be comprised in a cleaning composition, such as a cleaning composition according to the third aspect of the invention. In other words, the use or method of the invention may utilise a cleaning composition that comprises one or more biosurfactants.

The cleaning composition may further comprise one or more additive compounds independently selected from a non-biological anionic surfactant, a succinic acid derived dispersant and a terpene. The succinic acid derived dispersant typically also acts as a detergent.

By the term non-biological surfactant we mean a surfactant that is not a biosurfactant, suitably a surfactant that is not a product of a fermentation process.

The cleaning composition may comprise the one or more biosurfactants in any suitable amount. For example, the cleaning composition may comprise at least 1 wt %, such as at least 2 wt %, of the one or more biosurfactants, and/or the cleaning composition may comprise up to 5 wt %, such as up to 3 wt %, of the one or more biosurfactants. The cleaning composition may, for example, comprise from 1 to 10 wt %, for example from 2 to 10 wt %, or from 2 to 5 wt %, of the one or more biosurfactants.

Examples of suitable non-biological anionic surfactants include sulfated or sulfonated non-biological surfactants, such as alkyl sulfates (for example sodium dodecyl sulfate), alkyl ether sulfates (for example sodium lauryl ether sulfate, ammonium lauryl ether sulfate), alkyl aromatic sulfates and sulfonates (for example dodecyl benzene sulfonic acid (DDBSA), alkyl benzene sulfonates and alkyl naphthalene sulfonates), sulfosuccinates, olefin sulfonates (for example sodium C14-16 olefin sulfonate), and suitable salts thereof (such as alkali metal, alkaline earth metal, ammonium, amine and alkanolamine salts).

Suitable non-biological anionic surfactants for use in compositions of the third aspect of the invention include salts of C₁₂-C₁₈ carboxylic acids, ethoxylated carboxylic acids, ester carboxylates and ethoxylated ester carboxylates and sarcosinates. Other suitable anionic surfactants include sulfates and sulfonates, for example alkyl sulfates, alkyl ether sulfates, alcohol sulfates, alcohol ether sulfates, α-olefin sulfonates, linear alkyl sulfonates; and phosphate esters.

Suitable non-biological anionic surfactants may be selected from salts of fatty acids; alkali metal salts of mono- or dialkyl sulfates; mono- or dialkyl ether sulfates; lauryl ether sulfates; alkyl sulfonates; alkyl aryl sulfonates; primary alkane disulfonates; alkene sulfonates; hydroxyalkane sulfonates; alkyl glyceryl ether sulfonates; alpha-olefinsulfonates; alkyl phosphates; sulfonates of alkylphenolpolyglycol ethers; salts of alkyl sulfopolycarboxylic acid esters; alkyl sulfosuccinates and salts thereof, alkyl ether sulfosuccinates and salts thereof, acyl isethionates, non-acylated alkyl isethionates; fatty acid taurates; acyl taurates; amino acid surfactants such as glutamates and glycinates; products of condensation of fatty acids with oxy- and aminoalkanesulfonic acids; sulfated derivatives of fatty acids and polyglycols; alkyl and acyl sarcosinates; sulfoacetates; alkyl phosphates; alkyl phosphate esters; acyl lactates; alkanolamides of sulfated fatty acids and salts of lipoamino acids. Particularly exemplary salts of the above, where applicable, are the sodium, potassium, ammonium, magnesium and triethanolamine salts. Suitable ammonium cations include those derived from alkyl amines and alkanolamines. Preferred ammonium cations include isopropanolamine, isopropylamine, ethanolamine, diethanolamine, triethanolamine and 2-amino-2-methyl-1,3-propanediol (AMPD). Preferred ammonium cations include NH₄⁺ and the ammonium cation of triethanolamine.

Preferred non-biological anionic surfactants are selected from salts of fatty acids; alkyl sulfonates; alkyl aryl sulfonates; primary alkane disulfonates; alkene sulfonates; hydroxyalkane sulfonates; alkyl glyceryl ether sulfonates; alpha-olefinsulfonates; alkyl phosphates; sulfonates of alkylphenolpolyglycol ethers; salts of alkyl sulfopolycarboxylic acid esters; alkyl sulfosuccinates and salts thereof, alkyl ether sulfosuccinates and salts thereof, acyl isethionates, non-acylated alkyl isethionates; fatty acid taurates; acyl taurates; amino acid surfactants such as glutamates and glycinates; products of condensation of fatty acids with oxy- and aminoalkanesulfonic acids; alkyl and acyl sarcosinates; sulfoacetates; alkyl phosphates; alkyl phosphate esters; acyl lactates; and salts of lipoamino acids. Particularly exemplary salts of the above, where applicable, are the sodium, potassium, ammonium, magnesium and triethanolamine salts. Suitable ammonium cations include those derived from alkyl amines and alkanolamines. Preferred ammonium cations include isopropanolamine, isopropylamine, ethanolamine, diethanolamine, triethanolamine and 2-amino-2-methyl-1,3-propanediol (AMPD). Preferred ammonium cations include NH₄⁺ and the ammonium cation of triethanolamine.

Suitable sulfoacetates include acyl sulfoacetates, particularly sodium acyl sulfoacetates.

Suitable glutamate surfactants include acyl glutamates.

The cleaning composition may comprise the one or more non-biological anionic surfactants (when present) in any suitable amount. For example, the cleaning composition may comprise at least 0.25 wt %, such as at least 0.5 wt % or at least 1 wt %, of the one or more non-biological anionic surfactants, and/or the cleaning composition may comprise up to 5 wt %, such as up to 3 wt %, of the one or more non-biological anionic surfactants. The cleaning composition may, for example, comprise from 0.25 to 5 wt %, such as from 0.5 to 5 wt % or from 1 to 3 wt %, of the one or more non-biological anionic surfactants.

Any suitable succinic acid derived dispersant may be included in the cleaning composition, which dispersants, and methods of preparing them, are well known in the art. By succinic acid derived dispersant we mean to include both dispersants derived directly from succinic acid and dispersants derived from a reactive equivalent of succinic acid such as from an anhydride of succinic acid. For example, the dispersant may comprise a reaction product of succinic acid or an anhydride thereof and an amine compound.

For example, the succinic acid derived dispersant may comprise a hydrocarbyl substituted succinic anhydride or a derivative thereof. A common method of preparing a hydrocarbyl substituted succinic anhydride is by the reaction of maleic anhydride with an olefin using a chlorination route or a thermal route (the so-called “ene” reaction).

Examples of suitable hydrocarbyl substituents include n-octyl, n-decyl, n-dodecyl, tetrapropenyl, n-octadecyl, oleyl, chloroctadecyl, triacontanyl, etc. The hydrocarbyl substituents may be made from homo- or interpolymers (e.g. copolymers, terpolymers) of mono- and di-olefins having 2 to 10 carbon atoms, for example ethylene, propylene, 1-butene, isobutene, butadiene, isoprene, 1-hexene, 1-octene, etc. Preferably these olefins are 1-monoolefins. Alternatively, the hydrocarbyl substituent may be made from other sources, for example monomeric high molecular weight alkenes (e.g. 1-tetra-contene), aliphatic petroleum fractions, for example paraffin waxes and cracked analogues thereof, white oils, synthetic alkenes for example produced by the Ziegler-Natta process (e.g. poly(ethylene) greases) and other sources known to those skilled in the art. Any unsaturation in the substituent may if desired be reduced or eliminated by hydrogenation according to procedures known in the art.

Preferably the hydrocarbyl substituents are predominantly saturated, that is, they contain no more than one carbon-to-carbon unsaturated bond for every ten carbon-to-carbon single bonds present. Most preferably the hydrocarbyl substituents contain no more than one carbon-to-carbon non-aromatic unsaturated bond for every 50 carbon-to-carbon bonds present.

The hydrocarbyl substituents preferably comprise at least 10, more preferably at least 12, for example at least 30 or at least 40 carbon atoms. The hydrocarbyl substituents may comprise up to about 200 carbon atoms. Preferably the hydrocarbyl substituents have a number average molecular weight (Mn) of from 170 to 2800, for example from 250 to 1500, preferably from 500 to 1500 and more preferably 500 to 1100.

Preferred hydrocarbyl substituents are polyisobutenes. Such compounds are known to the person skilled in the art.

The succinic acid derived dispersant may comprise a mixture of compounds, such as a mixture of compounds having different hydrocarbyl substituents.

Preferred hydrocarbyl substituted succinic anhydrides are polyisobutenyl succinic anhydrides. These compounds are commonly referred to as “PIBSAs” and are known to the person skilled in the art.

Suitable polyisobutenyl succinic anhydrides may comprise conventional polyisobutenes and so-called “highly-reactive” polyisobutenes. Highly reactive polyisobutenes in this context are defined as polyisobutenes wherein at least 50%, preferably 70% or more, of the terminal olefinic double bonds are of the vinylidene type as described in EP0565285. Particularly preferred polyisobutenes are those having more than 80 mol % and up to 100 mol % of terminal vinylidene groups such as those described in U.S. Pat. No. 7,291,758. Preferred polyisobutenes have preferred molecular weight ranges as described above for hydrocarbyl substituents generally.

Suitable hydrocarbyl substituted succinic anhydride derivatives may be hydrocarbyl substituted succinimide compounds. Hydrocarbyl substituted succinimide compounds may be prepared by the reaction of a hydrocarbyl substituted succinic anhydride and an amine compound. Suitable amine compounds include polyamines and alkanol amines. Suitable polyamines may include (but are not limited to) alkylene polyamines (such as ethylenediamine, N,N-dimethylaminopropylamine, N,N-diethylaminopropylamine, N,N-dimethylamino ethylamine) and polyalkylene polyamines (such as polyethylene polyamines, for example diethylenetriamine, triethylenetetramine, tetraethylenepentamine, pentaethylenehexamine, hexaethylene-heptamine).

Suitable alkanol amines may include (but are not limited to) triethanolamine, trimethanolamine, N,N-dimethylaminopropanol, N,N-dimethylaminoethanol, N,N-diethylaminopropanol, N,N-diethylaminoethanol, N,N-diethylaminobutanol, N,N,N-tris(hydroxyethyl)amine, N,N,N-tris(hydroxymethyl)amine, N,N,N′-trimethyl-N′-hydroxyethyl-bisaminoethylether, N,N-bis(3-dimethylaminopropyl)-N-isopropanolamine, N-(3-dimethylaminopropyl)-N,N-diisopropanolamine, 2-(2-dimethylaminoethoxy ethanol, N,N,N′-trimethylaminoethylethanolamine, aminoethylethanolamine, N-(2-hydroxyethyl)ethylenediamine and 3-(2-(dimethylamino)ethoxy) propylamine.

The hydrocarbyl substituted succinic anhydride derivatives may be formed by the reaction of a polyisobutene-substituted succinic anhydride and a polyethylene polyamine. Suitable compounds are, for example, described in WO2009/040583.

The hydrocarbyl substituted succinic anhydride derivative may comprise the reaction product of a polyisobutene-substituted succinic anhydride and aminoethylethanolamine or a polyethylene polyamine from selected ethylenediamine, diethylenetriamine, triethylenetetramine, tetraethylenepentamine, pentaethylenehexamine, hexaethylene-heptamine and mixtures and isomers thereof; wherein the polyisobutene substituent has a number average molecular weight of between 500 and 2000, preferably between 600 and 1000.

The cleaning composition may comprise the one or more succinic acid derived dispersants (when present) in any suitable amount. For example, the cleaning composition may comprise at least 0.5 wt %, such as at least 1 wt %, of the one or more succinic acid derived dispersants, and/or the cleaning composition may comprise up to 5 wt %, such as up to 3 wt %, of the one or more succinic acid derived dispersants. The cleaning composition may, for example, comprise from 0.5 to 5 wt %, such as from 1 to 3 wt %, of the one or more succinic acid derived dispersants.

Examples of suitable terpenes may include mono-terpenes for example pinene and limonene. The terpene may be provided as part of a natural oil, for example orange oil or pine oil and may be present as one isomer or a mixture of isomers.

The cleaning composition may comprise the one or more terpenes (when present) in any suitable amount. For example, the cleaning composition may comprise at least 0.5 wt %, such as at least 1 wt %, of the one or more terpenes, and/or the cleaning composition may comprise up to 5 wt %, such as up to 3 wt %, of the one or more terpenes. The cleaning composition may, for example, comprise from 0.5 to 5 wt %, such as from 1 to 3 wt %, of the one or more terpenes.

The cleaning composition may further comprise an additional additive selected from one or more of a solvent, a pH adjusting agent, a preservative and a stabiliser. Suitable amounts of such additional additives (when present) would be known to persons skilled in the art.

The cleaning composition may further comprise one or more solvents. Suitable solvents include aromatic solvents (such as xylene and/or Aromatic 150), ethers (such as 2-butoxyethanol, also known as butyl cellosolve) and alcohols, especially C₁₋₆ alcohols (such as ethanol or isopropyl alcohol). Suitable amounts of solvent(s) (when present) may range from 45 to 95 wt %.

Examples of suitable pH adjusting agents may include caustic soda, cyclohexylamine and phosphoric acid. Suitable amounts of pH adjusting agent(s) (when present) may range from 0.5 to 2 wt %.

Examples of suitable stabilisers may include isopropyl alcohol and ethylene glycol monobutyl ether. Suitable amounts of stabilisers (when present) may range from 1 to 20 wt %.

Suitable preservatives and amounts thereof would be well known to persons skilled in the art.

The cleaning composition may further comprise one or more non-biological surfactants in addition to the non-biological anionic surfactant, which may be independently selected from a nonionic, cationic, amphoteric and zwitterionic surfactant.

Suitable non-biological nonionic, cationic, amphoteric or zwitterionic surfactants would be known to persons skilled in the art. Suitable amounts of non-biological surfactants (when present) may range from 0.1 to 20 wt %, such as from 0.1 to 10 wt %, preferably from 0.5 to 5 wt %.

Examples of suitable non-biological amphoteric surfactants include those based on fatty nitrogen derivatives and those based on betaines.

Suitable non-biological amphoteric or zwitterionic surfactants may be selected from betaines, for example alkyl betaines, alkylamidopropyl betaines, for example cocamidopropyl betaine, alkylamidopropyl hydroxy sultaines, alkylamphoacetates, alkylamphodiacetates, alkyl propionates, alkylamphodipropionates, alkylamphopropionates, alkyliminodipropionates and alkyliminodiacetate.

Suitable non-biological amphoteric or zwitterionic surfactants may include those which have an alkyl or alkenyl group of 7 to 22 carbon atoms and comply with an overall structural formula:

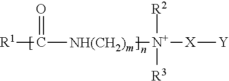

where R¹ is alkyl or alkenyl of 7 to 22 carbon atoms; R² and R³ are each independently alkyl, hydroxyalkyl or carboxyalkyl of 1 to 6 carbon atoms; m is 2 to 4; n is 0 or 1; X is alkylene of 1 to 6 carbon atoms optionally substituted with hydroxyl; and Y is —CO₂⁻ or —SO₃⁻.

Non-biological amphoteric or zwitterionic surfactants may include simple betaines of formula:

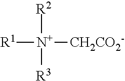

and amido betaines of formula:

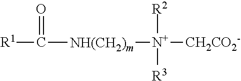

where m is 2 or 3.

In both formulae R¹, R² and R³ are as defined previously. R¹ may, in particular, be a mixture of C₁₂ and C₁₄ alkyl groups derived from coconut so that at least half, preferably at least three quarters, of the groups R¹ has 10 to 14 carbon atoms. R² and R³ are preferably methyl.

Non-biological amphoteric or zwitterionic surfactants may include sulfobetaines of formula:

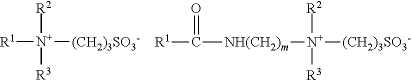

where m is 2 or 3, or variants of these in which —(CH₂)₃SO₃⁻ is replaced by:

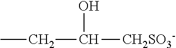

where R¹, R² and R³ in these formulae are as defined previously.

Non-biological amphoteric or zwitterionic surfactants may include amphoacetates and diamphoacetates. Amphoacetates generally conform to the following formula:

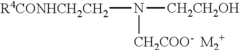

Diamphoacetates generally conform to the following formula:

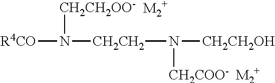

where R⁴ is an aliphatic group of 8 to 22 carbon atoms and M₂⁺ is a cation such as sodium, potassium, ammonium, or substituted ammonium.

Suitable acetate-based surfactants include lauroamphoacetate; alkyl amphoacetate; sodium alkyl amphoacetate; cocoampho(di)acetate; cocoamphoacetate; disodium cocoamphodiacetate; sodium cocoamphoacetate; disodium cocoamphodiacetate; disodium capryloamphodiacete; disodium lauroamphoacetate; sodium lauroamphoacetate and disodium wheatgermamphodiacetate.

Suitable betaine surfactants include alkylamido betaine; alkyl betaine, C_{12/14} alkyldimethyl betaine; cocoamidopropylbetaine; tallow bis(hydroxyethyl) betaine; hexadecyldimethylbetaine; cocodimethylbetaine; alkyl amido propyl sulfo betaine; alkyl dimethyl amine betaine; coco amido propyl dimethyl betaine; alkyl amido propyl dimethyl amine betaine; cocamidopropyl betaine; lauryl betaine; laurylamidopropl betaine, coco amido betaine, lauryl amido betaine, alkyl amino betaine; alkyl amido betaine; coco betaine; lauryl betaine; diemethicone propyl PG-betaine; oleyl betaine; N-alkyldimethyl betaine; coco biguamide derivative, C₈ amido betaine; C₁₂ amido betaine; lauryl dimethyl betaine; alkylamide propyl betaine; amido betaine; alkyl betaine; cetyl betaine; oleamidopropyl betaine; isostearamidopropyl betaine; lauramidopropyl betaine; 2-alkyl-N-carboxymethyl-N-hydroxyethyl imidazolinium betaine; 2-alkyl-N-carboxyethyl-N-hydroxyethyl imidazolinium betaine; 2-alkyl-N-sodium carboxymethyl-N-carboxymethyl oxyethyl imidazolinium betaine; N-alkyl acid amidopropyl-N,N-dimethyl-N-(3-sulfopropyl)-ammonium-betaine; N-alkyl-N,N-dimethyl-N-(3-sulfopropyl)-ammonium-betaine; cocodimethyl betaine; apricotamidopropyl betaine; isostearamidopropyl betaine; myristamidopropyl betaine; palmitamidopropyl betaine; alkamidopropyl hydroxyl sultaine; cocamidopropyl hydroxyl sultaine; undecylenamidopropyl betaine; cocoamidosulfobetaine; alkyl amido betaine; C_{12/18} alkyl amido propyl dimethyl amine betaine; lauryldimethyl betaine; ricinol amidobetaine; tallow aminobetaine.

Suitable glycinate surfactants include acyl glycinates such as cocoamphocarboxyglycinate; tallowamphocarboxygycinate; capryloamphocarboxyglycinate, oleoamphocarboxyglycinate, bis-2-hydroxyethyl tallow glycinate; lauryl amphoglycinate; tallow polyamphoglycinate; coco amphoglycinate; oleic polyamphoglycinate; N—C_{10/12} fatty acid amidoethyl-N-(2-hydroxyethyl)-glycinate; N—C_{12/18}-fatty acid amidoethyl-N-(2-hydroxyethyl)-glycinate; dihydroxyethyl tallow gycinate.

Preferred acetate-based amphoteric surfactants include sodium lauroamphoacetate, disodium lauroamphoacetate and mixtures thereof.

Preferred betaine surfactants include cocoamidopropyl betaine.

Preferred sultaine surfactants include cocoamidopropylhydroxy sultaine.

Examples of suitable non-biological nonionic surfactants may include alcohol alkoxylates such as alcohol ethoxylates, alcohol propoxylates, and ethylene oxide/propylene oxide copolymer derived surfactants, aliphatic esters, aromatic esters, sugar esters, especially sorbitan esters, alkyl polyglucosides, fatty acid alkoxylates such as fatty acid ethoxylates and fatty acid propoxylates or polyethylene glycol esters and partial esters, glycerol esters including glycerol partial esters and glycerol triesters, fatty alcohols (such as cetearyl alcohol, lauryl alcohol, stearyl alcohol, behenyl alcohol), alkanolamides and amineoxides.

Suitable non-biological nonionic surfactants may be selected from the following: reaction products of compounds having a hydrophobic group and a reactive hydrogen atom, for example aliphatic alcohols, acids, amides or alkyl phenols with alkylene oxides, especially ethylene oxide either alone or with propylene oxide (for example alkyl (C₆-C₂₂) phenol-ethylene oxide condensates, the condensation products of aliphatic (C₈-C₁₈) primary or secondary linear or branched alcohols with ethylene oxide, and products made by condensation of ethylene oxide with the reaction products of propylene oxide and ethylenediamine); long chain tertiary amine oxides, long chain tertiary phosphine oxides and dialkyl sulfoxides; alkyl amine oxides, alkyl amido amine oxides; alkyl tertiary phosphine oxides; alkoxyl alkyl amines; sorbitan; sorbitan esters; sorbitan ester alkoxylates; glycerol ester alkoxylates; sucrose esters; sugar amides, such as a polysaccharide amide; lactobionamides; and alkyl polysaccharide nonionic surfactants, for example alkylpolyglycosides.

Examples of suitable non-biological cationic surfactants may be based on fatty amine derivatives or phosphonium quaternary ions, and quaternary ammonium compounds. Polymeric cationic surfactants may also be used.

Suitable non-biological cationic surfactants may include tertiary amine salts, mono alkyl trimethyl ammonium chloride, mono alkyl trimethyl ammonium methyl sulfate, dialkyl dimethyl ammonium chloride, dialkyl dimethyl ammonium methyl sulfate, trialkyl methyl ammonium chloride and trialkyl methyl ammonium methyl sulfate.

Examples of suitable non-biological cationic surfactants may include quaternary ammonium compounds, particularly trimethyl quaternary compounds.

Preferred quaternary ammonium compounds may include cetyltrimethylammonium chloride, behenyltrimethylammonium chloride (BTAC), cetylpyridinium chloride, tetramethylammonium chloride, tetraethylammonium chloride, octyltrimethylammonium chloride, dodecyltrimethylammonium chloride, octyldimethylbenzylammonium chloride, hexadecyltrimethylammonium chloride, decyldimethylbenzylammonium chloride, stearyldimethylbenzylammonium chloride, didodecyldimethylammonium chloride, dioctadecyldimethylammonium chloride, tallowtrimethylammonium chloride, cocotrimethylammonium chloride, PEG-2 oleylammonium chloride and salts of these where the chloride is replaced by halogen (e.g. bromide), acetate, citrate, lactate, glycolate, phosphate nitrate, sulfate, or alkylsulfate.

Further suitable non-biological cationic surfactants may include those materials having the CTFA designations Quaternium-5, Quaternium-31 and Quaternium-18. Mixtures of any of the foregoing materials may also be suitable. A particularly useful cationic surfactant for use as a hair conditioning agent is cetyltrimethylammonium chloride, available commercially, for example as GENAMIN CTAC, ex Hoechst Celanese.

Salts of primary, secondary, and tertiary fatty amines are also suitable cationic surfactants. The alkyl groups of such amines preferably have from 12 to 22 carbon atoms, and can be optionally substituted.

Useful non-biological cationic surfactants include amido substituted tertiary fatty amines, in particular tertiary amines having one C12 to C22 alkyl or alkenyl chain. Such amines include stearamidopropyldimethylamine, stearamidopropyldiethylamine, stearamidoethyldiethylamine, stearamidoethyldimethylamine, palmitamidopropyldimethylamine, palmitamidopropyldiethylamine, palmitamidoethyldiethylamine, behenamidopropyldimethylamine, palmitamidoethyldimethylamine, behenamidopropyldiethylamine, behenamidoethyldiethylamine, behenamidoethyldimethylamine, arachidamidopropyldimethylamine, arachid amidopropyldiethylamine, arachidamidoethyldiethylamine, arachidamidoethyldimethylamine, diethylaminoethylstearamide.

Also useful are dimethylstearamine, dimethylsoyamine, soyamine, myristylamine, tridecylamine, ethylstearylamine, N-tallowpropane diamine, ethoxylated (with 5 moles of ethylene oxide) stearylamine, dihydroxyethylstearylamine, and arachidyl behenylamine.

These amines are typically used in combination with an acid to provide the cationic species. Suitable acids include L-glutamic acid, lactic acid, hydrochloric acid, malic acid, succinic acid, acetic acid, fumaric acid, tartaric acid, citric acid, L-glutamic hydrochloride, and mixtures thereof; more preferably L-glutamic acid, lactic acid, citric acid.

Other useful cationic amine surfactants include those disclosed in U.S. Pat. No. 4,275,055.

Suitable polymeric cationic surfactants may include polyquaternium-7, polyquaternium-10, polyquaternium-11, guar hydroxypropyltrimonium chloride, and hydroxypropyl guar hydroxypropyltrimonium chloride.

The one or more biosurfactants may be used to provide cleaning in any suitable manner. For example, the biosurfactants may be used to provide cleaning as a component of a cleaning composition (such as a cleaning composition of the third aspect of the invention). The one or more biosurfactants (or the cleaning composition) may be applied to a surface requiring cleaning in any suitable manner, such as application by any suitable means, optionally followed by curing under suitable conditions (such as at room temperature). Application may be by means of washing, spraying, dipping, brushing, soaking, wiping with a cloth or similar soaked with the cleaning composition.

According to a third aspect of the invention, there is provided a cleaning composition comprising one or more biosurfactants and one or more additive compounds independently selected from a non-biological anionic surfactant, a succinic acid derived dispersant and a terpene.

The cleaning composition may comprise any combination of the one or more additive compounds. For example, the cleaning composition may comprise one or more non-biological anionic surfactants and no succinic acid derived dispersant or terpene, or the cleaning composition may for example comprise one or more non-biological anionic surfactants and one or more succinic acid derived dispersants and no terpene, and so on covering all possible combinations of the additive compounds.

The cleaning composition may comprise one or more of each of the additive compounds and may comprise mixtures of different additive compounds when more than one such compound is used. For example, when reference is made to the cleaning composition comprising a non-biological surfactant this includes mixtures of different non-biological surfactants when more than one non-biological surfactant is comprised in the composition (with the same applying to the succinic acid derived dispersants and terpenes).

According to a third aspect of the invention, the cleaning composition may comprise one or more biosurfactants and two or more additive compounds independently selected from a non-biological anionic surfactant, a succinic acid derived dispersant and a terpene.

According to a third aspect of the invention, the cleaning composition may comprise one or more biosurfactants, one or more non-biological anionic surfactants, one or more succinic acid derived dispersants and optionally one or more terpenes.

According to a third aspect of the invention, the cleaning composition may comprise one or more biosurfactants, one or more non-biological anionic surfactants, one or more terpenes and optionally one or more succinic acid derived dispersants.

According to a third aspect of the invention, the cleaning composition may comprise one or more biosurfactants, one or more terpenes, one or more succinic acid derived dispersants and optionally one or more non-biological anionic surfactants.

According to a third aspect of the invention, the cleaning composition may comprise one or more biosurfactants, one or more non-biological anionic surfactants, one or more succinic acid derived dispersants and one or more terpenes.

Features of the cleaning composition of the third aspect of the invention, for example including of the biosurfactants, the non-biological anionic surfactants, succinic acid derived dispersants and terpenes and the additional additives comprised therein, are as set out herein in relation to the use and method of the first and second aspects.

In particular, in the cleaning composition of the third aspect of the invention, the one or more biosurfactants may be independently selected from a glycolipid, a lipopeptide, a phospholipid and a polymeric biosurfactant (and mixtures thereof). The one or more biosurfactants may be glycolipids, especially sophorolipids.

The cleaning composition of the third aspect of the invention may comprise the one or more biosurfactants in any suitable amount. For example, the cleaning composition may comprise at least 0.1 wt %, for example at least 1 wt %, such as at least 2 wt %, of the one or more biosurfactants, and/or the cleaning composition may comprise up to 15 wt %, for example up to 5 wt %, such as up to 3 wt %, of the one or more biosurfactants. The cleaning composition may, for example, comprise from 0.1 to 15 wt %, for example from 1 to 10 wt %, from 2 to 10 wt %, from 0.1 to 5 wt % or from 2 to 5 wt %, of the one or more biosurfactants.

The cleaning composition of the third aspect of the invention may comprise each of the one or more non-biological anionic surfactants, succinic acid derived dispersants and/or terpenes in any suitable amount (when present).

For example, the cleaning composition may comprise at least 0.25 wt %, such as at least 0.5 wt % or at least 1 wt %, of the one or more non-biological anionic surfactants (when present), and/or the cleaning composition may comprise up to 10 wt %, for example up to 5 wt %, such as up to 3 wt %, of the one or more non-biological anionic surfactants (when present). The cleaning composition may, for example, comprise from 0.25 wt % to 10 wt %, for example from 0.25 to 5 wt %, such as from 0.5 to 5 wt %, from 1 to 5 wt % or from 1 to 3 wt %, of the one or more non-biological anionic surfactants (when present).

For example, the cleaning composition may comprise at least 0.5 wt %, such as at least 1 wt %, of the one or more succinic acid derived dispersants (when present), and/or the cleaning composition may comprise up to 10 wt %, for example up to 5 wt %, for example up to 3 wt %, of the succinic acid derived dispersants (when present). The cleaning composition may, for example, comprise from 0.5 to 10 wt %, for example from 0.5 to 5 wt %, such as from 1 to 5 wt % or from 1 to 3 wt %, of the one or more succinic acid derived dispersants (when present).

For example, the cleaning composition may comprise at least 0.5 wt %, such as at least 1 wt %, of the one or more terpenes (when present), and/or the cleaning composition may comprise up to 10 wt %, for example up to 5 wt %, such as up to 3 wt %, of the one or more terpenes (when present). The cleaning composition may, for example, comprise from 0.5 to 10 wt %, for example from 0.5 to 5 wt %, such as from 1 to 5 wt % or from 1 to 3 wt %, of the one or more terpenes (when present).

The cleaning composition of the third aspect of the invention may further comprise an additional additive selected from one or more of a solvent, a pH adjusting agent, a preservative and a stabiliser, as discussed above.

The cleaning composition of the third aspect of the invention may further comprise one or more solvents. Suitable solvents include aromatic solvents (such as xylene and/or Aromatic 100), ethers (such as 2-butoxyethanol also known as butyl cellosolve) and alcohols, especially C1-6 alcohols (such as ethanol or isopropyl alcohol). Suitable amounts of solvent(s) range from 45 to 95 wt %.

The cleaning composition may further comprise one or more non-biological surfactants in addition to the non-biological anionic surfactant, which may be independently selected from a nonionic, cationic, amphoteric and zwitterionic surfactant.

Suitable non-biological nonionic, cationic, amphoteric or zwitterionic surfactants and amounts thereof are as discussed above in relation to earlier aspects of the invention.

The cleaning composition of the third aspect of the invention may comprise from 0.1 to 15 wt % (such as from 0.5 to 5 wt %) of one or more biosurfactants, from 0 to 10 wt % (such as from 1 to 5 wt %) of one or more non-biological anionic surfactants, from 0 to 10 wt % (such as from 1 to 5 wt %) of one or more succinic acid derived dispersants and from 0 to 10 wt % (such as from 1 to 5 wt %) of one or more terpenes.

The cleaning composition of the third aspect of the invention may comprise from 0.1 to 15 wt % (such as from 0.5 to 5 wt %) of one or more biosurfactants, from 0.25 to 10 wt % (such as from 1 to 5 wt %) of one or more non-biological anionic surfactants, from 0.25 to 10 wt % (such as from 1 to 5 wt %) of one or more succinic acid derived dispersants and from 0.25 to 10 wt % (such as from 1 to 5 wt %) of one or more terpenes.

### BRIEF DESCRIPTION OF DRAWINGS

For a better understanding of the invention, and to show how exemplary embodiments of the same may be carried into effect, reference will be made, by way of example only, to the accompanying diagrammatic Figures, in which:

FIG. 1 shows equal sized smears of asphalt series roof tar applied to a galvanized steel panel according to Example 1;

FIG. 2 shows the results of Example 1 following application of cleaning composition 1 and commercial cleaning product to the panel of FIG. 1;

FIG. 3 shows equal sized smears of 3M Super Adhesive applied to a galvanized steel panel according to Example 2; and

FIG. 4 shows the results of Example 2 following application of cleaning composition 1 and Goo Gone to the panel of FIG. 3.

The invention will now be further described with reference to the following non-limiting examples.

### Example 1

A cleaning composition 1 was prepared by blending the components as shown in Table 1:

TABLE 1

| Component | % By Weight |
|---|---|
| Xylene | 37 |
| Aromatic 100 | 37 |
| Isopropyl alcohol | 13 |
| Butyl cellosolve | 4 |
| DDBSA | 2 |
| PIBSI | 3 |
| Di-Pentene | 1 |
| Sophorolipid | 3 |

DDBSA = dodecyl benzene sulfonic acid
PIBSI = polyisobutylene succinimide prepared by reaction of 750MW PIBSA and tetraethylenepentamine; 60 wt % active solution prepared according to Additive A2 in U.S. Pat. No. 1,122,0647
Sophorolipid = commercially available sophorolipid with an acid/lactone ratio of 60:40

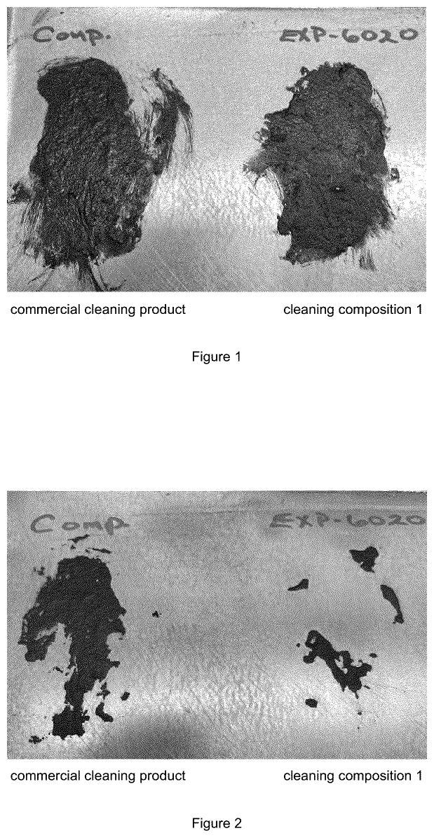

The cleaning ability of the cleaning composition 1 and a commercial cleaning product was tested in cleaning tar from a solid surface as follows:
1. Equal sized smears of asphalt series roof tar were applied to a galvanized steel panel as shown in FIG. 1.
2. The tar smears were allowed to cure for a minimum of two weeks in sunlight.
3. The cleaning composition 1 and commercial cleaning product were applied in equal amounts (2 sprays of formulation) to separate tar smears.
4. The products were allowed to soak for 3 minutes.
5. Using a paper towel, 15 consistent passes were made to remove tar from the surface. The scrub time equalled 30 seconds.
6. The visual results were recorded (see FIG. 2).

The cleaning composition 1 provided significantly improved cleaning performance compared to the commercial cleaning product by visual analysis as shown in FIG. 2 (compared to FIG. 1). The majority of the asphalt series roof tar was removed from the solid surface to which the cleaning composition 1 was applied. This was not the case for the surface to which the commercial cleaning product was applied.

### Example 2

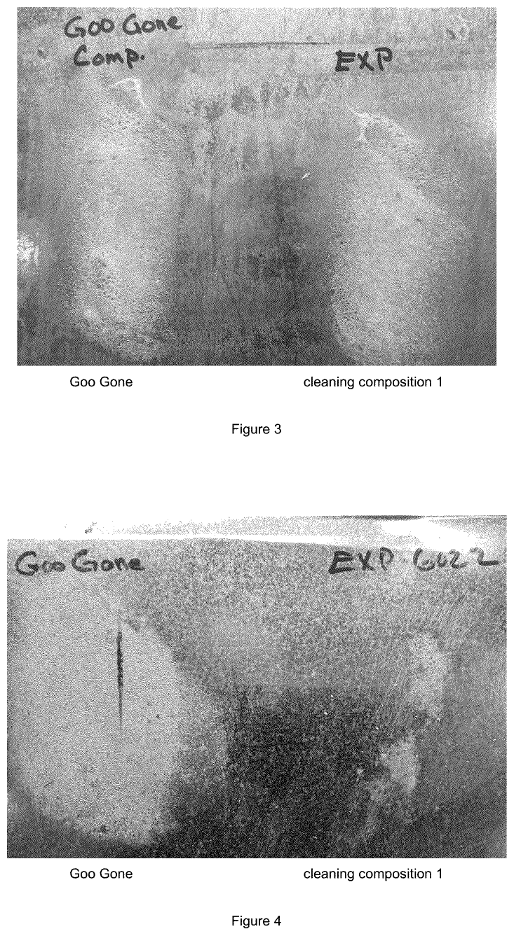

The cleaning ability of the cleaning composition 1 from Example 1 and a commercial cleaning product Goo Gone (manufactured by Weiman Products LLC) was tested in cleaning 3M Super Adhesive from a solid surface as follows:
1. Equal sized smears of 3M Super Adhesive were applied to a galvanized steel panel as shown in FIG. 3.
2. The adhesive smears were allowed to cure for a minimum of two weeks in sunlight.
3. The cleaning composition 1 and the Goo Gone were applied in equal amounts (2 sprays of formulation) to separate adhesive smears.
4. The products were allowed to soak for 90 seconds.
5. Using a Goo Gone plastic scraper, 15 consistent passes were made to remove adhesive from the surface. The scrub time equaled 30 seconds.
6. The visual results were recorded (see FIG. 4).

The cleaning composition 1 provided significantly improved cleaning performance compared to the commercial Goo Gone by visual analysis as shown in FIG. 4 (compared to FIG. 3). The majority of the 3M Super Adhesive was removed from the solid surface to which the cleaning composition 1 was applied. This was not the case for the surface to which the Goo Gone was applied.

The present invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. The use of one or more biosurfactants to provide cleaning to at least a portion of an item of industrial equipment.

2. A method of cleaning at least a portion of an item of industrial equipment, the method comprising contacting the portion of the item of industrial equipment with one or more biosurfactants.

3. The method of claim 2, wherein the cleaning comprises at least the partial removal of a substance from the portion of the item of industrial equipment wherein the substance is selected from one or more of oil, tar, asphalt, polymer, adhesive, grease, paint and sludge.

4. The method of claim 2, wherein the one or more biosurfactants are independently selected from a glycolipid, a lipopeptide, a phospholipid and a polymeric biosurfactant.

5. The method of claim 4, wherein the one or more biosurfactants are glycolipids.

6. The method of claim 5, wherein the one or more biosurfactants are independently selected from a rhamnolipid, a trehalolipid, a sophorolipid and a mannosylerythritol lipid, preferably wherein the one or more biosurfactants are sophorolipids.

7. The method of claim 4, wherein the one or more biosurfactants are lipopeptides, preferably wherein the one or more biosurfactants are independently selected from surfactin and lichenysin.

8. The method of claim 4, wherein the one or more biosurfactants are phospholipids.

9. The method of claim 4, wherein the one or more biosurfactants are polymeric biosurfactants, preferably wherein the one or more biosurfactants are independently selected from liposan, rufisan, emulsan and alasan.

10. The method of claim 2, wherein the one or more biosurfactants are comprised in a cleaning composition, wherein the cleaning composition further comprises one or more additive compounds independently selected from a non-biological anionic surfactant, a succinic acid derived dispersant and a terpene.

11. The method of claim 10, wherein the cleaning composition comprises from 1 to 10 wt % of the one or more biosurfactants.

12. The method of claim 2, wherein the industrial equipment is metallic equipment.

13. The method of claim 2, wherein the industrial equipment is oilfield equipment.

14. The method of claim 2, wherein the industrial equipment is selected from manufacturing, storage, processing, extraction, treatment and transportation equipment.

15. A cleaning composition comprising one or more biosurfactants and one or more additive compounds independently selected from a non-biological anionic surfactant, a succinic acid derived dispersant and a terpene.

16. The cleaning composition according to claim 15 comprising one or more biosurfactants, one or more non-biological anionic surfactants, one or more succinic acid derived dispersants and one or more terpenes.
